(19) United States
(12) Patent Application Publication
(10) Pub. No.: US 2012/0160818 A1
(43) Pub. Date: Jun. 28, 2012

(54) LASER MACHINING APPARATUS AND LASER MACHINING METHOD

(75) Inventors: Takanori Miyazaki, Tokyo (JP); Norihiro Seto, Aichi (JP)

(73) Assignee: MITSUBISHI ELECTRIC CORPORATION, Chiyoda-ku, Tokyo (JP)

(21) Appl. No.: 13/393,350

(22) PCT Filed: May 24, 2011
(86) PCT No.: PCT/JP2011/061888

§ 371 Date: Feb. 29, 2012

(30) Foreign Application Priority Data
Jun. 14, 2010 (JP) 2010-135027

(51) Int. Cl. B23K 26/38

(52) U.S. Cl. 219/121.72; 219/121.67

(57) ABSTRACT

A laser machining apparatus includes an irradiating section and a control section. The control section causes, in a first period, the irradiating section to perform a first cutting process for cutting a workpiece in a region between a first region and a second region in such a manner that a state in which the first region is retained by the second region in the workpiece is kept, and causes, in a second period later than the first period, the irradiating section to perform a second cutting process for cutting the workpiece within the region between the first region and the second region in the workpiece, where a rear surface is exposed because a part of the protective sheet has been melted in the first cutting process, to separate the first region from the second region together with dross adhering to the rear surface in the first cutting process.

### FIELD

The present invention relates to a laser machining apparatus and a laser machining method.

### BACKGROUND

The laser machining method is a machining method capable of machining a wide variety of materials from metals such as iron, stainless steel, aluminum, and copper to ceramic, resin, and wood. Among the materials, in some cases, a metal material is used as a material for design and surface finish such as mirror finish or hairline finish is applied to the metal material. Naturally, the material, the surface of which is finished for the purpose of design in this way, loses a commodity value thereof if its surface is scratched. Therefore, it is desirable that the metal material for design is subjected to transportation, cutting, and bending in a state in which protective sheets are stuck to the front surface and the rear surface thereof.

In particular, the laser machining method is a complicated machining method for melting a metal material with the heat of a laser beam and powerfully blowing the material with an assist gas to blow off the molten material. The blown-off molten material sometimes turns to fine sparks of fire and adheres to the front surface and the rear surface of the material. The material is subjected to laser machining in a state in which the material is fixed on a machining table. A distal end of the machining table in contact with the material is formed in a sharp shape to reduce a contact area with the material as much as possible such that the machining table is not melted by the laser beam to the extent possible and, such that even if the machining table is melted, the machining table is not welded integrally with the material. Because the machining table extremely easily scratches the rear surface of the material, it is desirable to machine the material while a protective sheet is kept stuck to the material.

However, when the laser machining is performed in a state in which the protective sheet is stuck to the rear surface (a laser beam non-irradiation surface) of the material, the speed of the flow of the metal melted by the heat of the laser beam is reduced by the influence of the protective sheet. As a result, the melted metal sometimes adheres to the rear surface of the material as dross. Because the dross is extremely hard, long time and large cost are required to remove the dross.

On the other hand, Patent Literature 1 teaches that the surface of a metal material is irradiated with laser to perform laser machining in a state in which a process paper sheet having an adhesive layer, which contains heat resistant particles and is repeelable, is stuck to the rear surface of the metal material. In this way, according to Patent Literature 1, it is possible to prevent adhesion of dross during the laser machining of the metal material.

Besides, Patent Literature 2 teaches that the surface of a tabular metal material is irradiated with laser to carry out laser machining in a state in which a protective sheet having an adhesive force of F[N/20 mm] is stuck to the rear surface of the tabular metal material and a protective sheet having an adhesive force satisfying a condition of P/F≦0.3 where the pressure of an assist gas to be supplied during machining is represented as P[MPa] is stuck to the front surface of the tabular metal material. In this way, according to Patent Literature 2, it is supposedly possible to suppress generation of dross.

### CITATION LIST

### Patent Literature

Patent Literature 1: Japanese Patent Application Laid-open No. H06-198461

Patent Literature 2: International Publication No. 2007/000915

### SUMMARY

### Technical Problem

In the technology described in Patent Literature 1, because it is necessary to contain the heat resistant particles in the adhesive layer of the process paper sheet (the protective sheet), cost involved in the laser machining increases. In the technology disclosed in Patent Literature 2, it is necessary to limit molecular weight, thickness and adhesion of the protective sheet. Patent Literatures 1 and 2 do not teach what should be done to reduce the dross without relying on a material of the protective sheet.

The present invention has been devised in view of the above and it is an object of the present invention to provide a laser machining apparatus and a laser machining method that can reduce dross without relying on a material of a protective sheet stuck to a workpiece.

### Solution to Problem

In order to solve the above-mentioned problems and to achieve the object, a laser machining apparatus according to one aspect of the present invention comprises: an irradiating section configured to apply laser on a front surface of a workpiece having a rear surface to which a protective sheet is stuck and the front surface on an opposite side of the rear surface; and a control section configured to control the irradiating section to cut a region between a first region and a second region in the workpiece, wherein the control section causes, in a first period, the irradiating section to perform a first cutting process for cutting the workpiece in a region between the first region and the second region in the workpiece in such a manner that a state in which the first region is retained by the second region in the workpiece is kept, and causes, in a second period later than the first period, the irradiating section to perform a second cutting process for cutting the workpiece within a region between the first region and the second region in the workpiece, where the rear surface is exposed because a part of the protective sheet has been melted in the first cutting process, to separate the first region from the second region together with dross adhering to the rear surface in the first cutting process.

### Advantageous Effects of Invention

According to the present invention, in the second period, the second cutting process is performed to remove the dross adhering to the rear surface in the first cutting process. Therefore, the dross adhering to the rear surface of the workpiece in the first period can be removed in the second period. In the second period, the second cutting process is performed to cut the workpiece in the region where the rear surface is exposed and not covered with the protective sheet. Therefore, melted metal less easily adheres to the rear surface of the workpiece as dross when the second cutting process is performed. In this way, since it is possible to suppress adhesion of dross to the rear surface in the second period while removing the dross adhering to the rear surface in the first period, the dross can be reduced without relying on a material of the protective sheet stuck to the workpiece.

### BRIEF DESCRIPTION OF DRAWINGS

FIG. 1 is a diagram illustrating the configuration of a laser machining apparatus according to an embodiment.

FIG. 2 is a flowchart showing a laser machining method in the embodiment.

FIG. 3 is a diagram illustrating an example of a machining pattern.

FIG. 4 is a view for explaining effects attained by the embodiment.

FIG. 5 is a view for explaining effects attained by the embodiment.

FIG. 6 is a chart showing an offset amount and a dross height in an experimental example.

FIG. 7 is a chart of an offset amount and a dross height in another experimental example.

### DESCRIPTION OF EMBODIMENTS

Now an embodiment of a laser machining apparatus according to the present invention will be described in more detail below with reference to the drawings. It is noted that the present invention is not limited by the embodiment.

### Embodiment

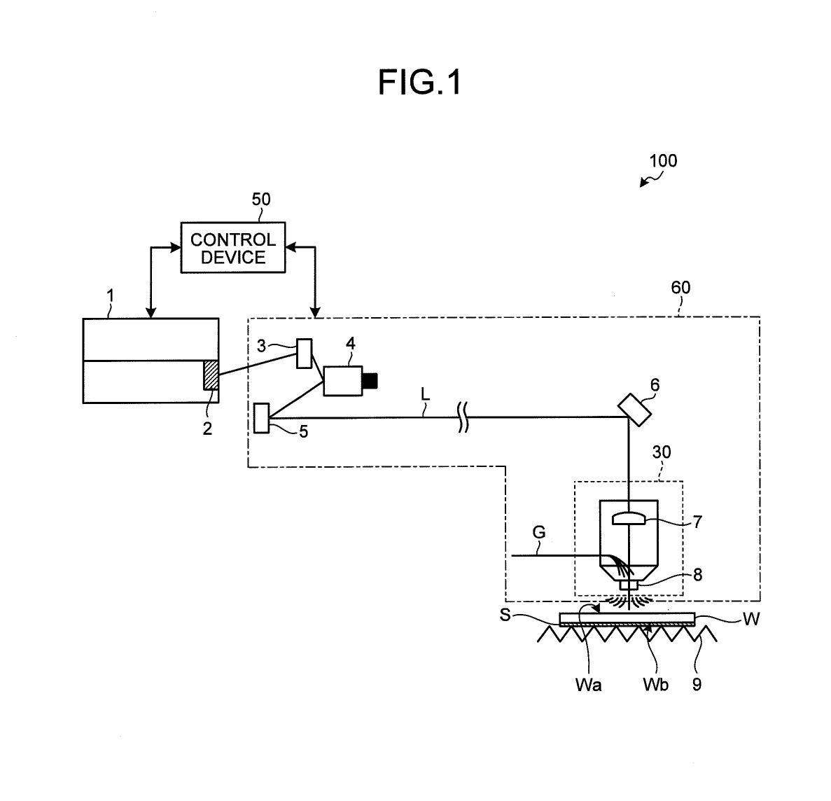

The configuration of a laser machining apparatus 100 according to an embodiment is described with reference to FIG. 1. FIG. 1 is a diagram illustrating a general configuration of the laser machining apparatus 100 according to the embodiment.

The laser machining apparatus 100 includes a laser oscillator 1, a PR (Partial Reflection) mirror 2, a laser-beam irradiating section 60, and a control device (a control section) 50.

The laser oscillator 1 is a device that oscillates a laser beam of a CO₂ laser or the like. The laser oscillator 1 emits a laser beam L to the laser-beam irradiating section 60 via the PR mirror 2 while variously changing an oscillation frequency and a laser output according to a type of laser machining process such as piercing process or cutting process.

The PR mirror (the partial reflection mirror) 2 partially reflects the laser beam emitted by the laser oscillator 1 and supports the oscillation of the laser beam by the laser oscillator 1. More specifically, the PR mirror 2 reflects a laser beam having an intensity lower than a predetermined value to return the laser beam to the laser oscillator 1, and transmits the laser beam amplified to an intensity equal to or higher than the predetermined value therethrough to lead the laser beam to the laser-beam irradiating section 60. In this way, the laser beam L amplified to the intensity equal to or higher than the predetermined value, of the laser beam emitted by the laser oscillator 1, is selectively led to the laser-beam irradiating section 60.

The laser-beam irradiating section 60 irradiates a workpiece (work) W with the laser beam L led from the laser oscillator 1. The workpiece W is placed on a surface of a machining table 9 having a plurality of sharp convexes.

The workpiece W has a rear surface Wb and a front surface Wa. The rear surface Wb is a surface opposed to the surface of the machining table 9, to which a protective sheet S for protecting the workpiece W from the sharp convex portions is stuck. Thereby, the rear surface Wb of the workpiece W is prevented from being scratched by the machining table 9 during the machining process. The front surface Wa is a surface on the opposite side of the rear surface Wb and serves as a face on which the laser beam L is applied by the laser-beam irradiating section 60. The workpiece W is made of, for example, metal.

The laser-beam irradiating section 60 includes a bend mirror 3, a beam optimizing unit 4, bend mirrors 5 and 6, and a machining head 30.

The bend mirror (a mirror for changing a beam angle) 3 changes a beam angle of the laser beam L led from the laser oscillator 1 via the PR mirror 2, to lead the laser beam L to the beam optimizing unit 4.

The beam optimizing unit (a beam-diameter changing device) 4 adjusts a beam diameter (a diameter) of the laser beam L led from the bend mirror 3 and changes the beam angle to lead the laser beam L to the bend mirror 5.

The bend mirrors 5 and 6 are mirrors for changing a beam angle. The bend mirror 5 deflects in beam angle the laser beam L led from the beam optimizing unit 4 to, for example, in a horizontal direction and leads the laser beam L to the bend mirror 6. The bend mirror 6 deflects in beam angle the laser beam L led from the bend mirror 5, for example, downward in a vertical direction and leads the laser beam L to the machining head 30. A not-shown mirror that changes a deflection direction may be installed between the bend mirror 5 and the bend mirror 6, as necessary.

The machining head 30 includes a machining lens 7 and a nozzle 8. The machining lens 7 condenses the laser beam L led from the bend mirror 6 in a small spot diameter and applies the laser beam L on the workpiece W. In the laser machining process, an assist gas G is blown against the workpiece W from the nozzle 8 simultaneously with the application of the laser beam.

The control device 50 is connected to the laser oscillator 1 and the laser-beam irradiating section 60 and controls the laser oscillator 1 and the laser-beam irradiating section 60. The control device 50 includes, for example, an NC (Numerical Control) device and controls the laser machining process (piercing process, cutting process, etc.) of the laser-beam irradiating section 60 using the NC device.

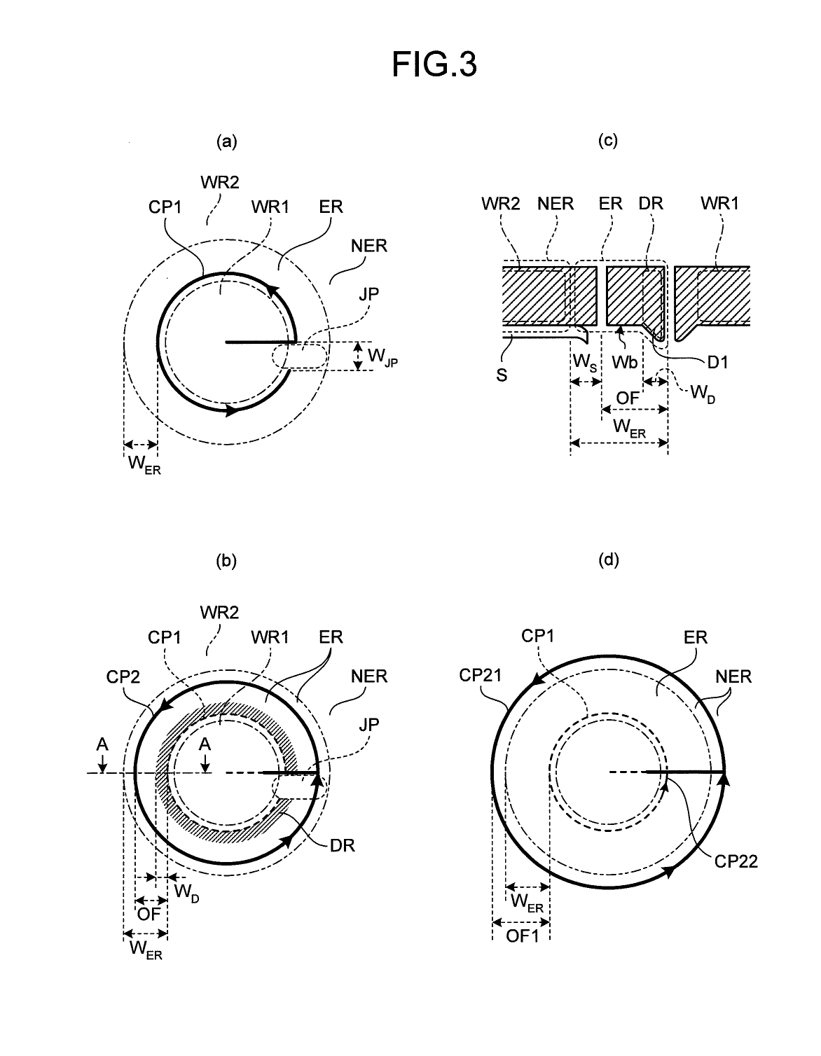

For instance, the control device 50 controls the laser-beam irradiating section 60 to cut a region between a first region WR1 and a second region WR2 in the workpiece W. Specifically, in a period (a first period) T1, the control device 50 causes the laser-beam irradiating section 60 to perform a first cutting process (rough machining process) for cutting the workpiece W in a region between the first region WR1 and the second region WR2 in the workpiece W in such a manner that a state in which the first region WR1 is retained by the second region WR2 in the workpiece W is kept. In the workpiece W, for example, the second region WR2 is arranged around the first region WR1 (see FIG. 3(a)). In a period (a second period) T2 after the period T1, the control device 50 causes the laser-beam irradiating section 60 to perform a second cutting process (finish machining process) for cutting the workpiece W in a region ER in such a manner that the first region WR1 is separated from the second region WR2 together with dross adhering to the rear surface Wb, generated in the first cutting process. The region ER is a region between the first region WR1 and the second region WR2 in the workpiece W, on which the rear surface Wb is exposed because a part of the protective sheet S has been melted in the first cutting process.

More specifically, in the period T1, the control device 50 causes the laser-beam irradiating section 60 to cut, while leaving a joint portion JP for connecting the first region WR1 and the second region WR2 in the workpiece W, the workpiece W in a region between the first region WR1 and the second region WR2 in the workpiece W such that the region ER where the rear surface Wb is exposed is formed in an annular shape between the first region WR1 and the second region WR2 in the workpiece W. In other words, the control device 50 causes the laser-beam irradiating section 60 to cut, while advancing along the outer circumference of the first region WR1 in the workpiece W, the workpiece W in a region between the first region WR1 and the second region WR2 in the workpiece W in such a manner that the joint portion JP in the workpiece W is left at a predetermined width W_{JP} (see FIG. 3(a)). The first region WR1 is, for example, a section to be finally removed in the workpiece W. The second region WR2 is, for example, a section to be finally left in the workpiece W. The joint portion JP is a section for connecting the first region WR1 and the second region WR2. The predetermined width W_{JP} is adjusted such that the region ER where the rear surface Wb is exposed is formed in an annular shape between the first region WR1 and the second region WR2 in the workpiece W.

If the width W_{JP} of the joint portion JP is too small, then a strength of the joint portion JP is insufficient with respect to a strength necessary for connecting the first region WR1 and the second region WR2, and so it is likely that the joint portion JP is broken. Alternatively, if the width W_{JP} of the joint portion JP is too large, then the region ER where the rear surface Wb is exposed becomes substantially a C-shaped region and does not become an annular region. Therefore, when the workpiece W is cut in an annular cutting pattern (see FIG. 3(b)) in the next period T2, the laser has to also pass a region covered with the protective sheet S on the rear surface Wb of the workpiece W, and thereby the dross easily adheres to the rear surface Wb of the workpiece W. So, the width W_{JP} of the joint portion JP needs to be adjusted to a value within a predetermined proper range.

In the period T2, the control device 50 causes the laser-beam irradiating section 60 to cut, to separate the first region WR1 from the second region WR2 together with the dross adhering to the rear surface Wb in the first cutting process (see FIG. 3(b)), the workpiece W in an annular pattern (a cutting pattern CP2) including a pattern offset from a pattern (a cutting pattern CP1) for the cutting in the period T1 in the workpiece W toward a side of the second region WR2 by a size OF. The size OF for offsetting the pattern is, as shown in FIG. 3(c), larger than a width W_{D} of a region DR (a region indicated by hatching in FIG. 3(b)) where dross D1 adheres to the rear surface Wb in the first cutting process in the region ER, but smaller than a width W_{ER} of the region ER where the rear surface Wb is exposed because a part of the protective sheet S has been melted in the first cutting process. The width W_{D} and the width W_{ER} are respectively widths in a direction from the pattern (the cutting pattern CP1) for the cutting in the period T1 toward a side of the second region WR2. FIG. 3(c) is a sectional view illustrating an A-A section of FIG. 3(b).

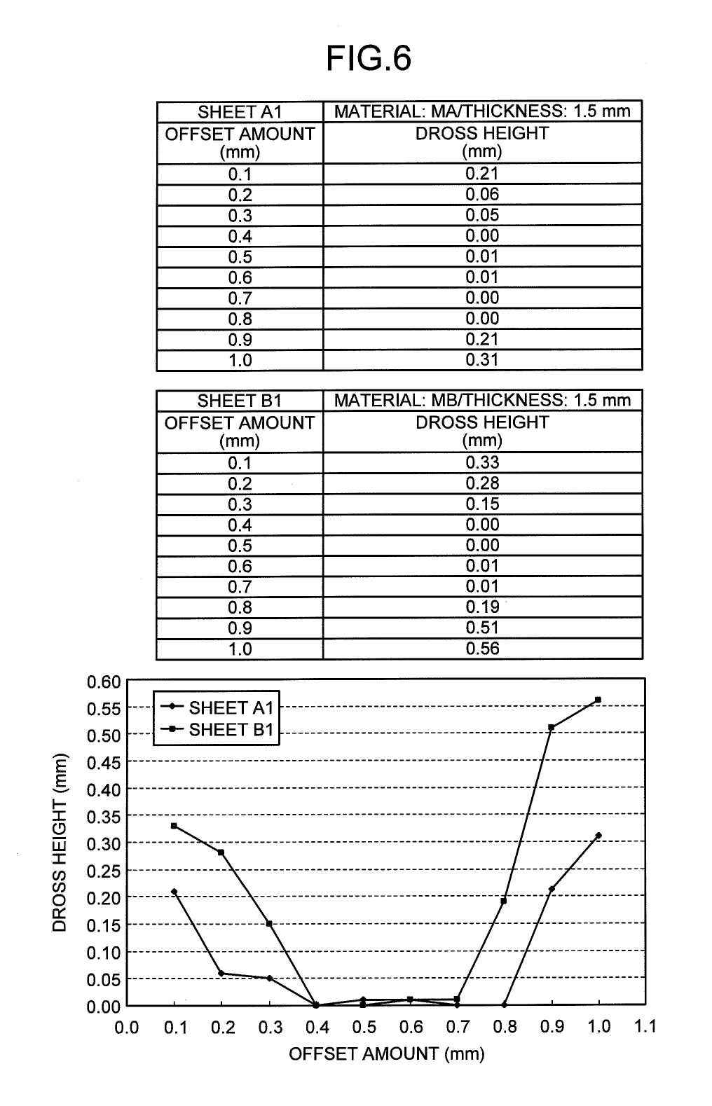

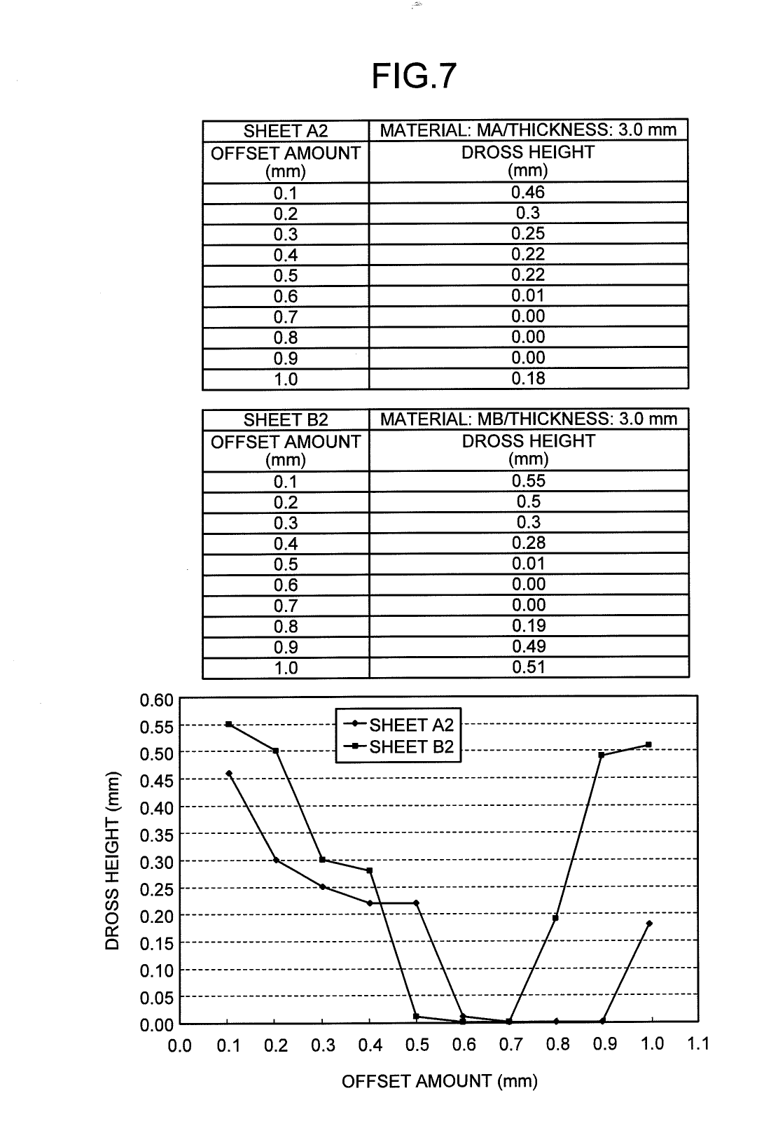

If the size OF for offsetting the pattern is smaller than W_{D}, when the second cutting process is performed, a part of the dross adhering to the rear surface Wb in the first cutting process remains without being removed, and so a height of the dross height after the machining process tends to be not sufficiently low (see FIGS. 6 and 7). Alternatively, if the size OF for offsetting the pattern is larger than W_{ER}, when the second cutting process is performed, the workpiece W is cut in a region NER where the rear surface Wb is covered with the protective sheet in the workpiece W, and so the dross height after the machining process tends to increase (see FIGS. 6 and 7).

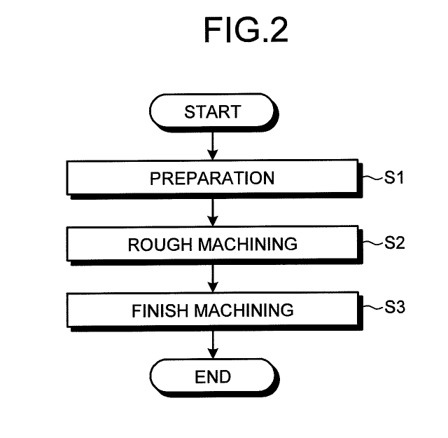

Next, a laser machining method performed by the laser machining apparatus 100 will be described with reference to FIG. 2. FIG. 2 is a flowchart showing a laser machining method in the embodiment.

At a step S1, the workpiece W is placed on the surface of the machining table 9. The workpiece W is formed of, for example, metal. Parameters (a rough machining condition and a finish machining condition) necessary for the machining process are inputted to an operation section (not shown) in the control device 50 by a user.

At a step S2 (a first cutting step), the control device 50 performs a first cutting (rough machining) process for cutting the workpiece W in a region between the first region WR1 and the second region WR2 in the workpiece W in such a manner that a state in which the first region WR1 is retained by the second region WR2 in the workpiece W is kept. Specifically, the control device 50 causes the laser-beam irradiating section 60 to cut, while leaving the joint portion JP for connecting the first region WR1 and the second region WR2 in the workpiece W, the workpiece W in a region between the first region WR1 and the second region WR2 in the workpiece W such that the region ER where the rear surface Wb is exposed is formed in an annular shape between the first region WR1 and the second region WR2 in the workpiece W. In other words, the control device 50 causes the laser-beam irradiating section 60 to cut, while advancing along the outer circumference of the first region WR1 in the workpiece W, the workpiece W in a region between the first region WR1 and the second region WR2 in the workpiece W in such a manner that he joint portion JP in the workpiece W is left at the predetermined width W_{JP} (see FIG. 3(a)). The first region WR1 is, for example, a section to be finally removed in the workpiece W. The second region WR2 is, for example, a section to be finally left in the workpiece W. The joint portion JP is a section for connecting the first region WR1 and the second region WR2.

More specifically, the workpiece W is cut along the cutting pattern CP1 shown in FIG. 3(a). The cutting pattern CP1 is, for example, a pattern that extends from near a (pierced) center of the first region WR1 to one end side of the joint portion JP toward the second region WR2 and extends from the one end side of the joint portion JP to the other end side of the joint portion JP along an outer circumference of the first region WR1 (for the workpiece W to be cut). If a cutting process is performed in this cutting pattern CP1, then a section of the width W_{ER} melts in the protective sheet S stuck to the rear surface Wb of the workpiece W. In other words, the region ER having the width W_{ER} where the rear surface Wb is exposed in the workpiece W is formed. At this point, the width W_{JP} of the joint portion JP is adjusted such that the region ER where the rear surface Wb is exposed in the workpiece W is formed as an annular region in a direction from the cutting pattern CP1 toward the second region WR2.

Herein, if the width W_{JP} of the joint portion JP is too small, then a strength of the joint portion JP is insufficient with respect to a strength necessary for connecting the first region WR1 and the second region WR2. Therefore, it is likely that the joint portion JP is broken before or during the machining process of the next step S3 and it becomes difficult to carry out the machining process of the next step S3. Alternatively, if the width W_{JP} of the joint portion JP is too large, the region ER where the rear surface Wb is exposed becomes substantially a C-shaped region and does not become an annular region when viewed in a direction perpendicular to the rear surface Wb. Thereby, when the workpiece W is cut in an annular cutting pattern at the next step S3, the region covered with the protective sheet S on the rear surface Wb of the workpiece W also has to be cut, so that the dross easily adheres to the rear surface Wb of the workpiece W. To this end, the width W_{JP} of the joint portion JP needs to be adjusted to a value within a predetermined proper range.

At a step S3 (a second cutting step), the control device 50 causes the laser-beam irradiating section 60 to perform the second cutting (finish machining) process for cutting the workpiece W in the region ER to separate the first region WR1 from the second region WR2 together with the dross adhering to the rear surface Wb in the first cutting process. The region ER is a region between the first region WR1 and the second region WR2 in the workpiece W and is a region where the rear surface Wb is exposed because a part of the protective sheet S has been melted in the first cutting process.

Specifically, the control device 50 causes the laser-beam irradiating section 60 to cut, to separate the first region WR1 from the second region WR2 together with the dross adhering to the rear surface Wb in the first cutting process (see FIG. 3(b)), the workpiece W in an annular pattern (the cutting pattern CP2) including a pattern offset from a pattern (the cutting pattern CP1) for the cutting in the period T1 in the workpiece W to a side of the second region WR2 by the size OF. The size OF for offsetting the pattern is, as shown in FIG. 3(c), larger than the width W_{D} of the region DR (the region indicated by hatching in FIG. 3(b)) where the dross D1 adheres to the rear surface Wb in the first cutting process in the region ER, but smaller than the width W_{ER} of the region ER where the rear surface Wb is exposed because a part of the protective sheet S has been melted in the first cutting process. The width W_{D} and the width W_{ER} are respectively widths in a direction from the pattern (the cutting pattern CP1) for the cutting in the period T1 toward a side of the second region WR2.

If the size OF for offsetting the pattern is smaller than W_{D}, when the second cutting process is performed, a part of the dross adhering to the rear surface Wb in the first cutting process remains without being removed and a dross height after the machining process tends to be not sufficiently low (see FIGS. 6 and 7). Alternatively, if the size OF for offsetting the pattern is larger than. W_{ER}, when the second cutting process is performed, the workpiece W is supposedly cut in the region NER where the rear surface Wb is covered with the protective sheet in the workpiece W. Therefore, the dross height after the machining process tends to increase (see FIGS. 6 and 7).

More specifically, the workpiece W is cut along the cutting pattern CP2 shown in FIG. 3(b). The cutting pattern CP2 is a substantially annular pattern that is obtained by offsetting the cutting pattern CP1 to a side of the second region WR2 by the size OF and extends to close itself across the joint portion JP. In other words, the cutting pattern CP2 is, for example, a pattern that extends from a (pierced) position offset by the size OF with respect to the vicinity of the center of the first region WR1 to one end side of the joint portion JP toward the second region WR2 and goes round from the one end side of the joint portion JP along the outer circumference of the first region WR1 to extend to the one end side of the joint portion JP (to cut the workpiece). In this way, the first region WR1 is separated from the second region WR2 in the workpiece W. Thus, a boring process for removing the first region WR1 from the workpiece W and leaving the second region WR2 is completed.

As a comparative example, a sample obtained by applying the processing at the steps S1 and S2 in FIG. 2 to the workpiece W and thereafter not applying the processing at the step S3 was evaluated. As the workpiece W, a tabular member formed of a material and having a thickness described below was used.
Material: stainless steel (SUS304)
Thickness: t 1.5 mm
As the laser machining apparatus 100, an apparatus having a machining lens and a nozzle opening diameter described below was used.
Machining lens: focal distance 5.0 inch
Nozzle opening diameter: φ 2.5 mm
At the step S1, for example, conditions described below were inputted to the operation section as conditions (parameters) that should be applied to the rough machining process (the first cutting process performed at the step S2).

### <Rough Machining Conditions>

Laser beam output: 1800 W
Laser beam wavelength: 10.6 μm
Machining speed: 5000 mm/min
Assist gas type: nitrogen
Assist gas pressure: 0.85 MPa
Focal position: 1 mm below the front surface Wa of the workpiece W
Nozzle to material distance: 0.5 mm

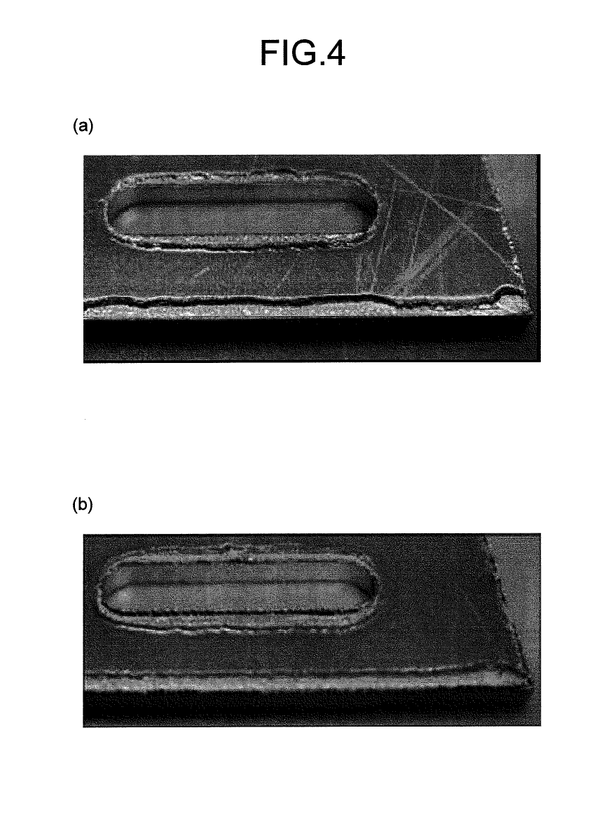

As a result, on the rear surface Wb of the obtained workpiece W, as shown in FIG. 4(b), a large number of pieces of dross adhered near a machined end face.

In order to check an effect obtained by the embodiment, as an example, a sample obtained by applying the processing at the steps S1, S2 and S3 shown in FIG. 2 to the workpiece W was evaluated. As the workpiece W, a workpiece same as that in the comparative example was used. At the step S1, conditions same as those in the comparative example were inputted to the operation section as conditions (parameters) that should be applied to the rough machining process (the first cutting process performed at the step S2). Also, conditions described below were inputted to the operation section as conditions (parameters) that should be applied to the finish machining process (the second cutting process performed at the step S3).

### <Finish Machining Conditions>

Laser beam output: 1400 W
Laser beam wavelength: 10.6 μm
Machining speed: 3500 mm/min
Assist gas type: nitrogen
Assist gas pressure: 0.85 MPa

Focal position: 1 mm below the front surface Wa of the workpiece W
Nozzle to material distance: 0.5 mm

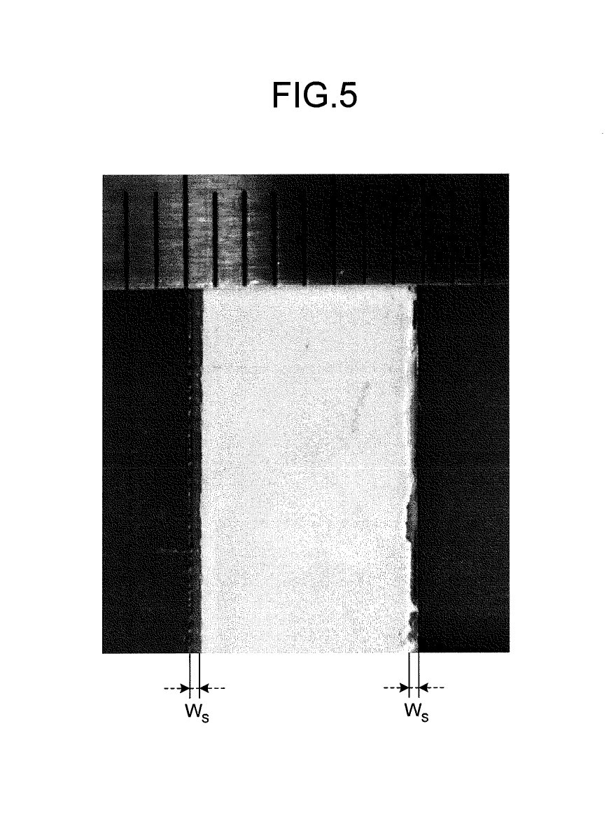

As a result, on the rear surface Wb of the obtained workpiece W, as shown in FIG. 4(a), dross hardly adhered near a machined end face thereof. As shown in FIG. 5, a width W_{S} (see FIG. 3(c)) of a region where the protective sheet S was peeled after the machining process was smaller than 1.0 millimeter. It was confirmed that, as a product quality, the width W_{S} was at a level for enabling production.

Although a result of an experiment performed concerning a workpiece made of stainless steel (SUS304) and having thickness t=1.5 mm is shown in FIG. 4, the same experiment was performed concerning workpieces having thicknesses t=1.0 mm, t=2.0 mm, t=3.0 mm, and t=4.0 mm and the same results were obtained. Therefore, it can be said that the machining method according to this embodiment can be applied irrespective of any thickness of a workpiece (a metal material) and the effect shown above can be obtained.

It is assumed that, in the period T2 (or at the step S3), the cutting process of the workpiece W is performed in the region NER on the outer side of the region ER where the rear surface Wb of the workpiece W is exposed. In this case, the workpiece W is cut along a cutting pattern CP21 shown in FIG. 3(d). The cutting pattern CP21 is a pattern obtained by offsetting the cutting pattern CP1 to a side of the second region WR2 by a size OF1 and closing itself. The size OF1 for offsetting the pattern is larger than the width W_{ER} of the region ER where the rear surface Wb is exposed because a part of the protective sheet S has been melted. In other words, because the workpiece W is cut in the region NER where the rear surface Wb is covered with the protective sheet in the workpiece W, the melt flow of the workpiece W (metal) melted by the heat of the laser beam tends to be reduced in velocity by the influence of the protective sheet S. As a result, in the period T2, the melted metal easily adheres to the rear surface Wb of the workpiece W as dross.

Alternatively, it is assumed that, in the period T2 (or at the step S3), the cutting process for cutting the joint portion JP in the workpiece W is performed. In this case, the workpiece W is cut along a cutting pattern CP22 shown in FIG. 3(d). The cutting pattern CP22 is a pattern that connects sections set apart via the joint portion JP in the cutting pattern CP1. Thus, the first region WR1 is separated from the second region WR2 in a state in which the dross adhering to the rear surface Wb in the first cutting process is left on a side of the second region WR2. Therefore, the dross adhering to the rear surface Wb in the period T1 can not be removed (see FIG. 4(b)).

On the other hand, in the embodiment, in the period T2 (or at the step S3), the second cutting process is performed to remove the dross adhering to the rear surface Wb in the first cutting process. Therefore, the dross adhering to the rear surface Wb in the first period can be removed in the second period. In the second period T2, the second cutting process is performed to cut the workpiece W in the region ER where the rear surface Wb is exposed. Therefore, melted metal less easily adheres to the rear surface Wb of the workpiece W as dross when the second cutting process is performed. In this way, it is possible to suppress adhesion of dross to the rear surface Wb in the period T2 while removing the dross adhering to the rear surface Wb in the period T1. Therefore, it is possible to reduce the dross without relying on a material of the protective sheet S stuck to the workpiece W (see FIG. 4(a)). As a result, it is possible to perform, irrespective of the molecular weight, the thickness, and the adhesive force of the protective sheet, machining with suppressed dross while using a generally-used protective sheet, and to realize production with time for the laser machining being further reduced.

In particular, in the period T2 (or at the step S3), the control device 50 causes the laser-beam irradiating section 60 to cut, to separate the first region WR1 from the second region WR2 together with the dross adhering to the rear surface Wb in the first cutting process, the workpiece W in an annular pattern (the cutting pattern CP2) including a pattern offset from a pattern (the cutting pattern CP1) for the cutting in the period T1 in the workpiece W to a side of the second region WR2 by the size OF. The size OF for offsetting the pattern is, as shown in FIG. 3(c), larger than the width W_{D} of the region DR where the dross D1 adheres to the rear surface Wb in the first cutting process in the region ER, but smaller than the width W_{ER} of the region ER where the rear surface Wb is exposed because a part of the protective sheet S has been melted in the first cutting process. In this way, when the first region WR1 is separated from the second region WR2, it is possible to suppress adhesion of dross to the rear surface Wb in the period T2 while removing the dross adhering to the rear surface Wb in the period T1.

Because the laser machining is performed with the protective sheet S being kept stuck to the rear surface Wb of the workpiece W, it is possible to prevent the rear surface Wb of the workpiece W from being scratched. Thereby, it is possible to provide the workpiece W as a finished product without spoiling design properties, i.e., a commodity value of the workpiece W subjected to surface finish such as mirror finish or hairline finish of the rear surface Wb of the workpiece W.

Alternatively, it is assumed that, in the period T1 (or at the step S2), a region between the first region WR1 and the second region WR2 in the workpiece W is cut to separate the first region WR1 from the second region WR2 in the workpiece W without leaving the joint portion JP. In this case, in the period T2 (or at the step S3), even in attempting to supply the assist gas G to a region to be formed as the cutting pattern CP2, the assist gas G escapes from an opening section formed by separating the first region WR1 in the workpiece W. Consequently, it is difficult to perform a finishing process (the second cutting process) along the cutting pattern CP2.

Alternatively, it is assumed that, in the period T1 (or at the step S2), a region between the first region WR1 and the second region WR2 in the workpiece W is cut in such a manner that the joint portion JP is left at a large width deviating from a predetermined proper range. In this case, the region ER where the rear surface Wb is exposed because the cutting is performed and a part of the protective sheet S has been melted becomes a region substantially a C-shaped region and does not become an annular region when viewed in a direction perpendicular to the rear surface Wb. Therefore, when the workpiece W is cut in the annular cutting pattern CP2 (see FIG. 3(b)) in the next period T2, even a region covered with the protective sheet S on the rear surface Wb of the workpiece W has to be cut. Thereby, it is difficult to suppress adhesion of the dross to the rear surface Wb in the period T2.

On the other hand, in the embodiment, in the period T1 (or at the step S2), a region between the first region WR1 and the second region WR2 in the workpiece W is cut while leaving the joint portion JP in such a manner that the region ER where the rear surface Wb is exposed between the first region WR1 and the second region WR2 in the workpiece W is formed in an annular shape. In this way, in the period T2 (or at the step S3), the assist gas G can be easily supplied to a region to be formed as the cutting pattern CP2, so that it becomes easy to perform the finish machining process (the second cutting process) along the cutting pattern CP2. Since the region ER where the rear surface Wb is exposed because the cutting process is performed and a part of the protective sheet S has been melted is an annular region, when the workpiece W is cut in the annular cutting pattern CP2 in the next period T2, it is easy to cut the workpiece W within the region ER. In other words, it is possible to perform cutting along the annular cutting pattern CP2 in the period T2, and at the same time it is easy to suppress adhesion of the dross to the rear surface Wb in the period T2.

It is noted that the control device 50 may set a machining speed of the laser in the period T2 (or at the step S3) lower than a machining speed of the laser in the period T1 (or at the step S2) and may set an output of the laser in the period T2 smaller than an output of the laser in the period T1. In this situation, a heat quantity applied to the workpiece W in the period T2 can be set equal to a heat quantity applied to the workpiece W in the period T1. Consequently, it is easy to improve a quality of the machining implemented by the laser machining process in the period T1 and the period T2.

A positional relation between the first region WR1 and the second region WR2 that are to be separated by the cutting process is not limited to that shown in FIG. 3. For instance, in the workpiece W, the first region WR1 and the second region WR2 may be adjacent to each other, rather than one being surrounded by the other. In this case, the workpiece W may be a tabular member or be a bar-like member.

### EXPERIMENT EXAMPLE

Concerning a sample obtained by applying the processing at the steps S1, S2 and S3 in FIG. 2 to the workpiece W, evaluation of an offset amount and a dross height of the finish machining process (the second cutting process) was performed. Relations between the offset amounts and the dross heights of the finish machining process (the second cutting process) obtained as a result are shown in FIGS. 6 and 7. FIG. 6 is a result obtained by evaluating, concerning protective sheets (a sheet A1 and a sheet B1) made of different two kinds of materials MA and MB, a tabular member (the workpiece W) having 1.5 millimeters in thickness. FIG. 7 is a result obtained by evaluating, concerning protective sheets (a sheet A2 and a sheet B2) made of the different two kinds of materials MA and MB, a tabular member (the workpiece W) having 3.0 millimeters in thickness. Machining conditions in this experiment are as mentioned below.

For the protective sheets (the sheet A1 and the sheet A2) made of the material MA, a protective sheet having many uses in a laser machining field was used. For the protective sheets (the sheet B1 and the sheet B2) made of the material MB, a protective sheet generally sold for industrial use was used. As an adhesive layer of the protective sheet, an adhesive layer much the same as an adhesive layer of the protective sheet generally sold for industrial use was used.

As the workpiece W, a workpiece made of a material and having a thickness defined below was used.
Material: stainless steel (SUS304)
Thickness: t 1.5 mm, t 3.0 mm
As the laser machining apparatus 100, an apparatus having a machining lens and a nozzle defined below was used.
Machining lens: focal distance 5.0 inches
Nozzle opening diameter: φ 2.5 mm

In the experiment shown in FIG. 6, as the machining conditions at the step S2, conditions defined below were used.

### <Rough Machining Conditions>

Laser beam output: 1800 W
Laser beam wavelength: 10.6 μm
Machining speed: 5000 mm/min
Assist gas type: nitrogen
Assist gas pressure: 0.85 MPa
Focal position: 1 mm below a material surface
Nozzle to material distance: 0.5 mm
As the machining conditions at the step S3, conditions defined below were used.

### <Finish Machining Conditions>

Laser beam output: 1400 W
Laser beam wavelength: 10.6 μm
Machining speed: 3500 mm/min
Assist gas type: nitrogen
Assist gas pressure: 0.85 MPa
Focal position: 1 mm below the material surface
Nozzle to material distance: 0.5 mm

In the experiment shown in FIG. 7, as the machining conditions at the step S2, conditions defined below were used.

### <Rough Machining Conditions>

Laser beam output: 4000 W
Laser beam wavelength: 10.6 μm
Machining speed: 4000 mm/min
Assist gas type: nitrogen
Assist gas pressure: 1.0 MPa
Focal position: 2 mm below the material surface

Nozzle to material distance: 0.5 mm
As the machining conditions at the step S3, conditions defined below were used.

### <Finish Machining Conditions>

Laser beam output: 3500 W
Laser beam wavelength: 10.6 μm
Machining speed: 3500 mm/min
Assist gas type: nitrogen
Assist gas pressure: 1.0 MPa
Focal position: 2 mm below the material surface
Nozzle to material distance: 0.5 mm

As a result, as shown in FIGS. 6 and 7, it was confirmed that, although a result was varied depending on the thickness of the workpiece W, as the offset amount was increased from 0.1 millimeter, the dross height decreased, and, approximately from the offset amount around 0.5 millimeters, the dross height tended to decrease to a negligible level and, approximately from the offset amount exceeding 0.7 millimeters, the dross height tended to increase to an innegligible level.

In this way, it was confirmed that, if the offset amount was too small, because a part of the dross adhering to the rear surface Wb of the workpiece W in the period T1 (or at the step S2) remained without being removed, the dross height was not sufficiently low. In addition, it was confirmed that, if the offset amount was too large, because the offset amount exceeded a width of a part of the protective sheet melted by the rough machining process (i.e., the width W_{ER} of the section ER where the rear surface Wb was exposed in the workpiece W), the dross tended to adhere to the rear surface Wb of the workpiece W because of the influence of the protective sheet in the period T2 (or at the step S3), and thereby the dross height increased.

In general, in the laser machining, any post-processing is not required as long as the dross height is equal to or smaller than 0.05 millimeters. Numerical value ranges of an offset amount satisfying this condition are, for example, as described below.
Sheet A1: 0.4 mm or more and 0.8 mm or less
Sheet B1: 0.4 mm or more and 0.7 mm or less
Sheet A2: 0.6 mm or more and 0.9 mm or less
Sheet B2: 0.5 mm or more and 0.7 mm or less
It can be understood from FIGS. 6 and 7 that satisfactory cutting quality has been realized using the offset amount within such numerical ranges.

### INDUSTRIAL APPLICABILITY

As described above, the laser machining apparatus and the laser machining method according to the present invention are useful for any laser machining processes of a workpiece to which a protective sheet is stuck.

### Reference Signs List

1 LASER OSCILLATOR

2 PR MIRROR

3 BEND MIRROR

4 BEAM OPTIMIZING UNIT

5 BEND MIRROR

6 BEND MIRROR

7 MACHINING LENS

8 NOZZLE

9 MACHINING TABLE

30 MACHINING HEAD

50 CONTROL DEVICE

60 LASER-BEAM IRRADIATING SECTION

100 LASER MACHINING APPARATUS

DR REGION

ER REGION

G ASSIST GAS

JP JOINT PORTION

L LASER BEAM

NER REGION

S PROTECTIVE SHEET

W WORKPIECE

Wb REAR SURFACE

Wa FRONT SURFACE

WR1 FIRST REGION

WR2 SECOND REGION

1. A laser machining apparatus comprising:
an irradiating section configured to apply a laser beam on a front surface of a workpiece having a rear surface to which a protective sheet is stuck and the front surface on an opposite side of the rear surface; and
a control section configured to control the irradiating section to cut a region between a first region and a second region in the workpiece, wherein
the control section causes, in a first period, the irradiating section to perform a first cutting process for cutting the workpiece in a region between the first region and the second region in the workpiece in such a manner that a state in which the first region is retained by the second region in the workpiece is kept, and causes, in a second period later than the first period, the irradiating section to perform a second cutting process for cutting the workpiece within a region between the first region and the second region in the workpiece, where the rear surface is exposed because a part of the protective sheet has been melted in the first cutting process, to separate the first region from the second region together with dross adhering to the rear surface in the first cutting process.

2. The laser machining apparatus according to claim 1, wherein
the second region is situated around the first region in the workpiece, and
the control section causes, in the first period, as the first cutting process, the irradiating section to cut, while leaving a joint portion for connecting the first region and the second region in the workpiece, the workpiece in a region between the first region and the second region in the workpiece in such a manner that a region where the rear surface is exposed is formed in an annular shape between the first region and the second region in the workpiece.

3. The laser machining apparatus according to claim 2, wherein the control section causes, in the second period, as the second cutting process, the irradiating section to cut, to separate the first region from the second region together with the dross adhering to the rear surface in the first cutting process, the workpiece in an annular pattern including a pattern offset from a pattern for the cutting in the first cutting process in the workpiece to a side of the second region by a size smaller than a width of the region where the rear surface is exposed.

4. The laser machining apparatus according to claim 1, wherein the control section sets a machining speed of the laser in the second period lower than a machining speed of the laser in the first period and sets an output of the laser in the second period smaller than an output of the laser in the first period.

5. The laser machining apparatus according to claim 2, wherein the control section sets a machining speed of the laser in the second period lower than a machining speed of the laser in the first period and sets an output of the laser in the second period smaller than an output of the laser in the first period.

6. The laser machining apparatus according to claim 3, wherein the control section sets a machining speed of the laser in the second period lower than a machining speed of the laser in the first period and sets an output of the laser in the second period smaller than an output of the laser in the first period.

7. A laser machining method for applying a laser beam on a front surface of a workpiece having a rear surface to which a protective sheet is stuck and the front surface on an opposite side of the rear surface and cutting a region between the first region and the second region in the workpiece,
the second region being situated around the first region in the workpiece,
the laser machining method comprising:
a first cutting step of cutting, while leaving a joint portion for connecting the first region and the second region in the workpiece, the workpiece in a region between the first region and the second region in the workpiece in such a manner that a region where the rear surface is exposed is formed in an annular shape between the first region and the second region in the workpiece; and
a second cutting step of cutting, to separate the first region from the second region together with dross adhering to the rear surface in the first cutting step, the workpiece in an annular pattern including a pattern offset from a pattern for the cutting in the first cutting step in the workpiece to a side of the second region by a size smaller than a width of the region where the rear surface is exposed.
